(19) United States
(12) Patent Application Publication
(10) Pub. No.: US 2009/0234983 A1
(43) Pub. Date: Sep. 17, 2009

(54) METHODS AND APPARATUS FOR SHARING A COMPUTER DISPLAY SCREEN

(75) Inventors: Stuart Alan Golden, Portland, OR (US); Adi Ronen, Beaverton, OR (US)

Correspondence Address: STOEL RIVES LLP - PDX, 900 SW FIFTH AVENUE, SUITE 2600, PORTLAND, OR, 97204-1268, US

(73) Assignee: Golden Signals, Inc., Beaverton, OR (US)

(21) Appl. No.: 12/182,929

(22) Filed: Jul. 30, 2008

Related U.S. Application Data
(60) Provisional application No. 61/069,573, filed on Mar. 17, 2008.

(51) Int. Cl. G06F 13/38; G06F 3/00

(52) U.S. Cl. 710/30

(57) ABSTRACT

A method masquerades computer display screen graphics data as a media stream supported by a media adapter with capabilities to receive a media stream, decompress it, and display it on an attached display device. The display screen graphics data is uncompressed pixel-level data representing graphics content displayable on a display screen attached to the computer in a normal display mode. The method processes the display screen graphics data, including compressing, to yield processed display screen graphics data in a compressed format supported by the media adapter and packages the processed display screen graphics data as a media stream. The method configures the computer to be a media server and transmits the media stream from the computer to the media adapter, thereby facilitating display on the display device of the graphics content, substantially cloning or extending what appears on at least a portion of the display screen attached to the computer.

### RELATED APPLICATIONS

Priority is claimed under 35 U.S.C. §119 to U.S. provisional application No. 61/069,573, filed Mar. 17, 2008, entitled “Method for Sending A/V Display of a Notebook to a Large Screen TV or Entertainment System,” which is incorporated herein in its entirety.

### TECHNICAL FIELD

The field of this disclosure relates generally to computer graphics processing and selective visual display systems, and more particularly but not exclusively to plural display systems.

### BACKGROUND INFORMATION

Computer display screens typically require a physical connection to a computer either internally or externally via a cable and are predominantly designed to render a graphical user interface associated with one set of input devices connected to the computer. For these reasons, a computer display is usually dedicated to an individual user rather than a larger audience.

On the other hand, modern wide-audience media display devices, such as televisions and projectors, were developed specifically to accommodate larger groups in household living rooms, home theaters, or conference-room environments. Wide-audience media displays have developed independently from personal computers or computer displays and they are unencumbered by computer keyboards. Unfortunately, however, this separate development has also resulted in frequent incompatibility between computer displays and wide-audience displays, as they often lack a common standardized audio/visual (A/V) cable connection by which to connect a computer video output or they cannot properly accommodate the video resolutions of a computer display.

With digital media becoming increasingly accessible, more users are acquiring and collecting the media directly on their computers as opposed to via television broadcasts or tangible media specifically suited for wide-audience media displays and associated accessories. Increasingly, television viewers are choosing to time-shift television broadcasts to watch them on their computers, which are often portable, rather than their wide-audience display devices. All of these users are subsequently unable to easily enjoy the benefits of their wide-audience media display for their computer media.

Experiencing computer slide-show presentations, documents, or other computer media content on a wide-audience media display is at times a preferable way to experience A/V data, particularly in large-group settings. Compared with computer displays, wide-audience media displays offer the benefits of a larger display area, typically feature higher-quality sound systems, and are increasingly capable of displaying high-definition video content. Additionally, many wide-audience media displays are connected to network-centric accessories, e.g., video gaming systems, that enable display of media files from remote media libraries residing on networked computers.

One technique that attempts to harness the benefits of wide-audience media displays for use to view computer media content relies on physically cabled connections. This technique has been facilitated by standardized A/V cable interfaces, but not every computer and wide-audience media display share a common cable connector. Furthermore, cabling also suffers from the cable's constraints: The cables have limited length; switching the cable to other computers to accommodate a multi-user model is cumbersome; and not all cable connections can support high bandwidth requirements. In general, those techniques lack mobility, dynamic computer display switching, and ease of use.

Other techniques that facilitate sharing computer display content on wide-audience media displays rely on proprietary dedicated wired or wireless connections from the computer to a wide-audience media display. According to those techniques, the computer initiates a specialized connection so that it can transmit media content for display on the wide-audience media display. Sometimes the connections are facilitated through an intermediate device that receives transmitted media content and provides a physical interface with a wide-audience media display via standardized A/V cables. Because these methods and systems are typically proprietary, interoperability is limited. Any computer attempting to transmit media content to the wide-audience media display must possess the specific proprietary hardware and software protocols required for transmission and reception of the media. In general, these techniques lack commonality and necessitate custom hardware.

### BRIEF DESCRIPTION OF THE DRAWINGS

FIG. 1 is a simplified diagram of an end-to-end system according to one embodiment.

FIG. 2 is a simplified diagram of an end-to-end system with multiple computers, according to another embodiment.

FIG. 3 is a depiction of a computer with add-on external hardware circuitry, according to one physical form factor.

FIG. 4 is a high-level block diagram of the computer with add-on external hardware circuitry in FIG. 3.

FIG. 5 is a depiction of a computer with add-on external hardware circuitry, according to another physical form factor.

FIG. 6 is a high-level block diagram of the computer with add-on external hardware circuitry in FIG. 5.

FIG. 7 is a depiction of a computer with a plug-in expansion card that provides hardware circuitry, according to one embodiment.

FIG. 8 is a depiction of a computer with internal add-on hardware circuitry, according to another embodiment.

FIG. 9 is high-level block diagram of computer-side hardware according to yet another embodiment.

FIG. 10 is a simplified block diagram of a computer architecture according to one or more embodiments.

FIG. 11 is a computer memory diagram showing software modules and routines according to one embodiment.

FIG. 12 is a flowchart of a method according to one embodiment.

FIG. 13 is a flowchart of a method according to another embodiment.

FIG. 14 is a block diagram of a system performing one step of the method of FIG. 13, according to one embodiment.

FIG. 15 is a flowchart of a method for selecting one of a multiple of computers, according to one embodiment.

FIG. 16 is a flowchart of a method for selecting one of a multiple of computers, according to another embodiment.

### DETAILED DESCRIPTION OF EMBODIMENTS

With reference to the above-listed drawings, this section describes particular embodiments and their detailed construction and operation. The embodiments described herein are set forth by way of illustration only and not limitation. Those skilled in the art will recognize in light of the teachings herein that there are alternatives, variations and equivalents to the example embodiments described herein. For example, other embodiments are readily possible, variations can be made to the embodiments described herein, and there may be equivalents to the components, parts, or steps that make up the described embodiments.

For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

### I. Overview

As one skilled in the art will appreciate in light of this disclosure, certain embodiments may be capable of achieving certain advantages, including, in some cases, some or all of the following: (1) sharing a desktop display with a large audience via a display suitable for wide-audience viewing; (2) utilizing existing media adapters to facilitate the transfer of the desktop graphics data; (3) permitting a user of a local computer to initiate the display sharing feature by operation of a control at the local computer; (4) sharing associated audio with the graphics data and thereby taking advantage of a typically higher quality sound system associated with the wide-audience display device; (5) having a low latency between the viewed shared desktop and the wide-audience display device; (6) supporting multiple computers with a simple interface to select which computer will share its desktop graphics data; and (7) utilizing proximity to add autonomy to determine which computer should connect to which wide-audience display. These and other advantages of various embodiments will be apparent upon reading this document.

According to one embodiment, a method masquerades computer display screen graphics data as a media stream supported by a media adapter. The media adapter has capabilities to receive a media stream, to decompress a received media stream and to interface with a display device to cause the display device to display video content represented by decompressed received media stream. The display screen graphics data is uncompressed pixel-level data generated by the computer and stored in a frame buffer in the computer so as to represent graphics content displayable on a display screen attached to the computer when the computer operates in a normal display mode. The method processes the display screen graphics data as the graphics data is generated by the computer, wherein the processing includes compressing, to yield processed display screen graphics data in a compressed format supported by the media adapter. The method then packages the processed display screen graphics data as a media stream. The method also configures the computer to be a media server of the media stream to the media adapter. The method transmits the media stream from the computer to the media adapter, thereby facilitating display on the display device of the graphics content, substantially cloning or extending what appears on at least a portion of the display screen attached to the computer.

According to another embodiment, a computer system has the capability to masquerade computer display screen graphics data as a media stream supported by a media adapter. The computer system comprises a computer that generates the display screen graphics data as pixel-level data and stores the display screen graphics data in a frame buffer. The computer system also comprises a display screen connected to the computer and nearby the computer, wherein images representing the graphics content are displayable on the display screen when the computer operates in a normal display mode. The computer system also comprises a module that processes the display screen graphics data as the graphics data is generated by the computer, wherein the processing includes compressing, to yield processed display screen graphics data in a compressed format supported by the media adapter. The computer system also comprises a module that packages the processed display screen graphics data as a media stream, software that configures the computer to be a media server of the media stream to the media adapter, and a transmitter that transmits the media stream from the computer to the media adapter, thereby facilitating display on the display device of the graphics content, substantially cloning or extending what appears on at least a portion of the display screen.

According to another embodiment, a device can be used with a computer to masquerade computer display screen graphics data as a media stream supported by a media adapter. The device comprises processing circuitry for processing the display screen graphics data as the graphics data is generated by the computer. The processing circuitry includes compression circuitry, to yield processed display screen graphics data in a compressed format supported by the media adapter. A module associated with the computer packages the processed display screen graphics data as a media stream so that when the computer is configured to be a media server of the media stream to the media adapter and when the media stream is transmitted from the computer to the media adapter, the graphics content is displayed on the display device, thereby substantially cloning or extending what appears on at least a portion of the display screen attached to the computer.

According to another embodiment, a system comprises a media adapter and a computer. The media adapter has capabilities to receive the media stream, to decompress a received media stream and to interface with a display device to cause the display device to display video content represented by decompressed received media stream. A processing module at the computer that processes the display screen graphics data as the graphics data is generated by the computer, wherein the processing circuitry includes compression circuitry, to yield processed display screen graphics data in a compressed format supported by the media adapter. A module at the computer that packages the processed display screen graphics data as a media stream so that when the computer is configured to be a media server of the media stream to the media adapter and when the media stream is transmitted from the computer to the media adapter, the graphics content is displayed on the display device, thereby substantially cloning or extending what appears on at least a portion of the display screen attached to the computer. The system may optionally include the display device interfaced to the media adapter.

According to another embodiment, a method determines which one of a plurality of computers should be selected to wirelessly send video to a media adapter having capabilities to wirelessly receive video data and to interface with a display device to cause the display device to display video content represented by video data. The method comprises estimating a proximity between the media adapter and each of the plurality of computers, thereby producing a plurality of proximity estimates, and selecting the computer having the minimum proximity estimate.

According to another embodiment, a method selects one of a plurality of computers most recently requesting to have its video content displayed on the display device. The method detects activation of an input at one of the plurality of computers that signifies a desire by a user of said one of the plurality of computers to have its video data displayed on the display device. As a result of detection of the input, the method discontinues display of any video content originating from any of the plurality of computers other than said one of the plurality of computers, receives video data originating from said one of the plurality of computers, displays on the display device video content represented by the received video data originating from said one of the plurality of computers, and continues to display on the display device said video content represented by the received video data originating from said one of the plurality of computers until detecting activation of an input at another one of the plurality of computers that signifies a desire by a user of said another one of the plurality of computers to have its video data displayed on the display device.

According to yet other embodiments, computer-readable media can be embedded with program code for implementing any of the above methods, systems and apparatus.

Additional details concerning the construction and operation of particular embodiments are set forth in the following subsections with reference to the above-listed drawings.

### II. Systems and Apparatuses

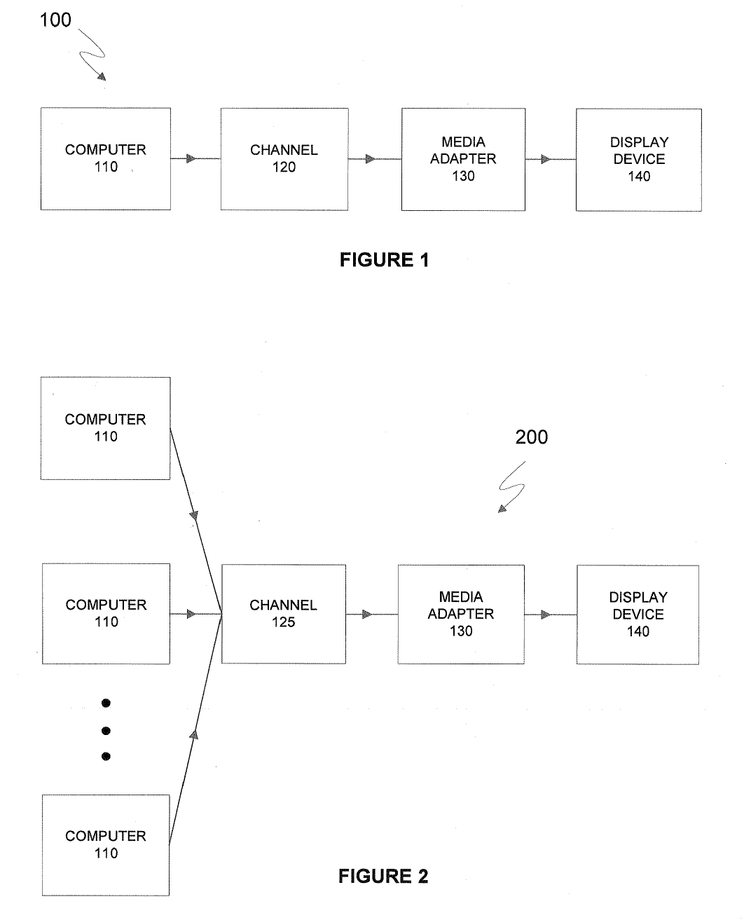

FIG. 1 is a simplified block diagram of an end-to-end system according to one embodiment. The system 100 comprises a computer or computer system 110, a channel 120, a media adapter 130, and a display device 140. The system 100 is useful in sharing the video content from a local display screen associated with the computer 110 with a potentially larger audience for whom the display device 140 is visible or more easily visible than the local display screen associated with the computer 110. The display device 140 may be, for example, a television or a projector and is typically designed for use by multiple viewers. The display device 140 may be a standard-definition or high-definition device. The system 100 may be located in a home living room, theatre, business office, conference room, or any other setting.

The computer 110 can masquerade its local display screen graphics data as a media stream to facilitate its display on the display device 140. The computer 110 sends the media stream to the media adapter 130. The media adaptor 130 has capabilities to receive a media stream or file from a remote computer, to process the received media stream as necessary (e.g., decompression), and to interface with the display device 140 to cause the display device 140 to display the video content represented by the media stream. The media adapter 130 is preferably a pre-existing, standardized, non-proprietary device. The media adapter 130 may be a stand-alone device or may be integrated within another device, such as the display device 140 or a gaming system. Gaming systems that presently incorporate media adapters include the Xbox 360® system from Microsoft Corp. and the Playstation 3® system from Sony, Inc. Current televisions that include a media adapter include the Smartmedia TV from Hewlett-Packard Co. The media adapter 130 may be a Windows® media extender (WME) or Windows® media adapter (WMA) designed to operate with some versions of the Windows® operating system from Microsoft Corp.

The local display screen graphics data is typically uncompressed graphics data generated by the computer 110 and stored in a frame buffer within the computer 110. The frame buffer is a pixel-by-pixel data representation of the local display screen of the computer 110. The contents of the frame buffer represents what is shown on the local display screen. In some settings, what is shown on the local display screen is referred to as the “desktop” and may include such graphical objects as windows, icons, menus, bars and the like. The system 100 is capable of sharing the desktop of the computer 110 to a wider audience via the display device 140.

The computer 110 processes its local display screen graphics data as that data is generated, preferably on the fly. That processing includes compression into a format supported by the media adaptor 130. The computer 110 packages the processed graphics data as a media stream that is supported by the media adapter 130. The media stream is preferably a gapless MPEG (Motion Picture Experts Group) compliant data stream rendered by sampling the video output or frame buffer of the computer 110 and applying temporal and/or spatial compression algorithms, but any type of compression and/or media stream format supported by the media adapter 130 can be used. The computer 110 is configured to be a media server, serving the media stream to the media adapter 130. The media stream is thereafter received by the media adapter 130, decompressed, and passed to the display device 140 via a suitable display device physical interface.

As shown in FIG. 1, the computer 110 passes the media stream to the media adapter 130 via a transmission channel 120. The channel 120 may be hard-wired but is preferably wireless. The channel 120 preferably operates according to the Internet Protocol (IP). The channel 120 may comprise a LAN (Local Area Network, which may be wireless (WLAN). In one example, the channel 120 operates according to a WiFi wireless link operating according to an IEEE (Institute of Electronics and Electrical Engineers) 802.11 standard (e.g., 802.11n) and the media adapter may be an 802.11 access point. Alternatively, a combination of wired and wireless links may be used. For example, the computer may be connected to a wireless network via a 802.11 a/big/n adapter but the media adapter may be connected via a wire (e.g., Ethernet cabling) to switches and/or access point(s). Thus, the interfaces on both sides of channel 120 may not necessarily be homogenous. Alternatively, other wireless communication protocols, such as Bluetooth or Ultra-Wideband (UWB) may be employed.

Use of the system 100 permits display on the display device 140 the desktop graphics data of the computer 110. In a normal display mode, the desktop graphics data appears only on the local display screen associated with the computer 110. However, the system 100 can cause the same or related content to appear on the display device 140. According to one example of use, the display device 140 clones or substantially clones at least a portion of what appears on the local display screen of the computer 110. The local display screen may or may not be blanked, put into background mode or otherwise altered during this period of cloning. According to another example of use, the display device 140 becomes an extension of the local display screen of the computer 110 in the same or a similar way as a second local display screen can be configured to extend the primary display screen above, below, or in another direction.

In the system 100, the computer 110 presents its desktop to the media adapter 130, preferably in real time, as something that looks like a file to the media adapter 130 in a format that the media adapter 130 expects and accepts without the user needing to think about format compatibilities or nuances associated with a particular media adapter. In other words, the computer 110 converts its desktop video into a media stream or file that the media adapter 130 is designed to play. In this way, the computer 110 takes advantage of the existing capability of the media adapter and leverages that ability to provide new functionality—namely, sharing of the computer's local display. The media adapter 130 is not otherwise designed to display a computer desktop. The computer 110 appears to the media adapter 130 as an A/V media server with a single item (e.g., an WMP11 file) in its content directory. That item is the computer's desktop video. When the computer 110 publishes its content directory, the media adapter 130 sees the single file therein and requests it. The computer 110 then configures its compression parameters to match the media adapter's settings and sends the desktop in a compressed format according to those parameters.

The computer 110 may also generate audio data that is normally played on a speaker or speaker set (not shown) integrated within or electrically connected to the computer 110. The audio data is preferably also processed and transmitted along with the graphics data for playback on the display device 140 or associated equipment, which often features a higher quality sound system than typically found on a computer. The audio data may be processed separately from the graphics data or together. The audio data is preferably packaged with the video data as part of the same media stream transmitted to the media adapter 130.

Changeover from normal display mode to a remote display mode, in which the remote display device 140 is activated, may be initiated by action by the user of the computer 110. The initiating action may be depression of a keyboard button, such as a function key, or operation of a point-and-click device, such as a mouse. The computer 110 may run a background process to detect the action and to crossover in response. A disabling action, such as a subsequent depression of the same key, can cause the computer 110 to revert to the normal state.

FIG. 2 is a simplified end-to-end block diagram of a system 200, according to another embodiment. Unlike the single-computer system 100 in FIG. 1, the system 200 has a plurality of computers 110, each of which is capable of operating in the manner described above in relation to FIG. 1. According to one embodiment, the computers 110 and the media adapter 130 are networked together via a multi-user communication channel 125. The computers 110 may register with the media adapter 130, or vice versa, by use of a discovery protocol, such as universal plug and play (UPnP). Selection of which one of the computers 110 to drive the display device 140 can be accomplished in various ways. For example, the selection can be made by operation of the user interface for the media adapter 130, by which a user makes an affirmative selection, typically by use of a remote control device navigating through menus displayed on the display device 140. A preferable alternative is for the selection to be made automatically. According to one such alternative, each computer 110 locally executes a software program to detect activation of an input, such as a button press, indicating a desire to drive the display device 140. The software manages requests to establish which computer 110 is currently permitted to transmit media data into the channel 130 and to coordinate any changes in transmission to the computers 110 in the network. For example, the software may monitor the requests to direct the media adapter 130 to change which networked computer 110 will drive the display device 140 currently displayed. Various protocols for the selection of a computer 110 and for changeover are possible. For example, according to one protocol, any request by any one of the computers 110 is granted, and the most recently granted request keeps control of the display device 140 until another computer 110 request it. According to another protocol, the computer 110 having the closest estimated proximity to the media adapter 130 is selected. Proximity can be estimated by measuring signal strength and/or by utilizing timestamps embedded in the signals transmitted between the computers 110 and the media adapter 130 or by other any other suitable means.

The computers 110 can take various forms, some representative examples of which are illustrated in the following figures and described below. The computers 110 may be computers per se or computer systems having additional devices connected to them.

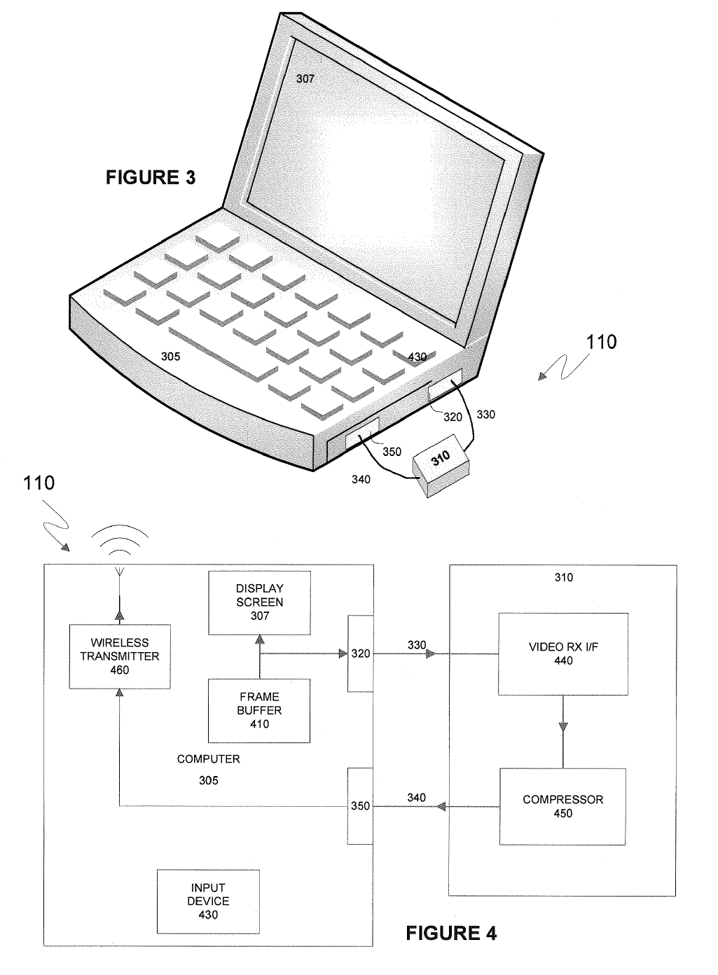

FIG. 3 depicts one example of a computer system 110 with add-on external hardware circuitry 310, according to one physical form factor. As shown in FIG. 3, the computer system 110 comprises a computer per se 305 and detachable external hardware circuitry 310. The computer 305 is shown as a laptop or notebook type computer but it could be a desktop, handheld (e.g., smartphone) or other type of computer. The computer 305 includes a local display screen 307 and one or more input devices such as a keyboard and/or pointer device. Because data compression and related processing can sometimes be a computationally intensive process it can be desirable to offload some or all of that processing from the computer's internal CPU (central processing unit) to dedicated hardware. The circuitry 310 is connected to a video output interface 320 of the computer 305 via a video cable 330. Modern computers typically provide a video output interface 320 digitally via a DVI (Digital Visual Interface) or HDMI (High-Definition Multimedia Interface) standard video port connector or in analog form via a VGA (Video Graphics Array) or other standard video port connector. Using a return cable 340, the external hardware circuitry 310 outputs the processed data into a data interface port 350, preferably a USB (Universal Serial Bus) port of the computer 305.

FIG. 4 is a high-level block diagram of the computer system 110 with the add-on external hardware circuitry 310 depicted in FIG. 3. FIG. 4 shows some of the more pertinent components of the computer 305 and the external hardware circuitry 310 employed in generating a data stream suitable for transmission as depicted in FIG. 1. Included within the computer 305 is a frame buffer 410 that preferably stores pixel-level graphics data both to a local display screen 307 and to the video output interface 320. As noted above, the external hardware circuitry 310 preferably works in conjunction with a video cable 330, an affixed plug-in connector, or other suitable connecting mechanism that can be connected to the video output interface 320 with a corresponding video port connector.

When a user wishes to activate the external hardware circuitry 310 for sharing his or her computer display screen 307, he or she can activate an input device such as a mouse pointer or keyboard key 430 on the computer 305. When activated, a video receiver interface 440 within the external hardware circuitry 310 samples the graphics data stored in the frame buffer at a suitable frame rate and resolution (e.g., an MPEG compliant frame rate and resolution). A compressor 450 in the external hardware circuitry 310 compresses the graphics data to create a data stream that can accommodate the bandwidth limitations imposed by the transmission channel 120 and the maximum allowable data rate of the media adapter 130. Following compression, the compressed and otherwise processed media stream is outputted from the external hardware circuitry 310 into an external data interface port 350 of the computer 305 via a return cable 340 having a bus connector that plugs into the data interface port 350. In the embodiment illustrated in FIG. 4, the media stream is then wirelessly transmitted via a wireless transmitter 460 to the media adapter 130.

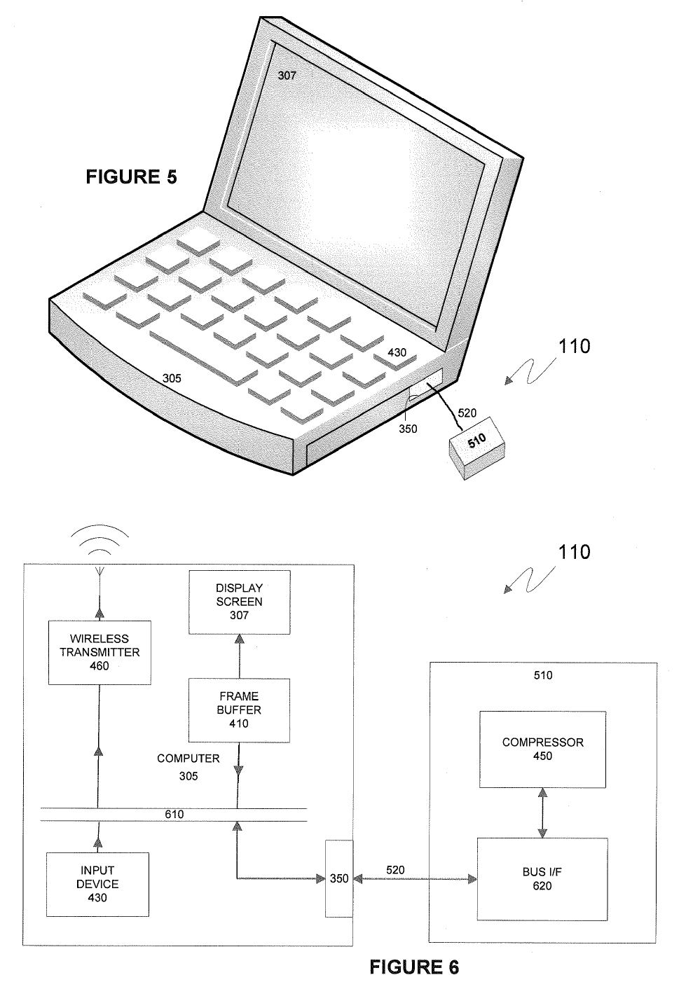

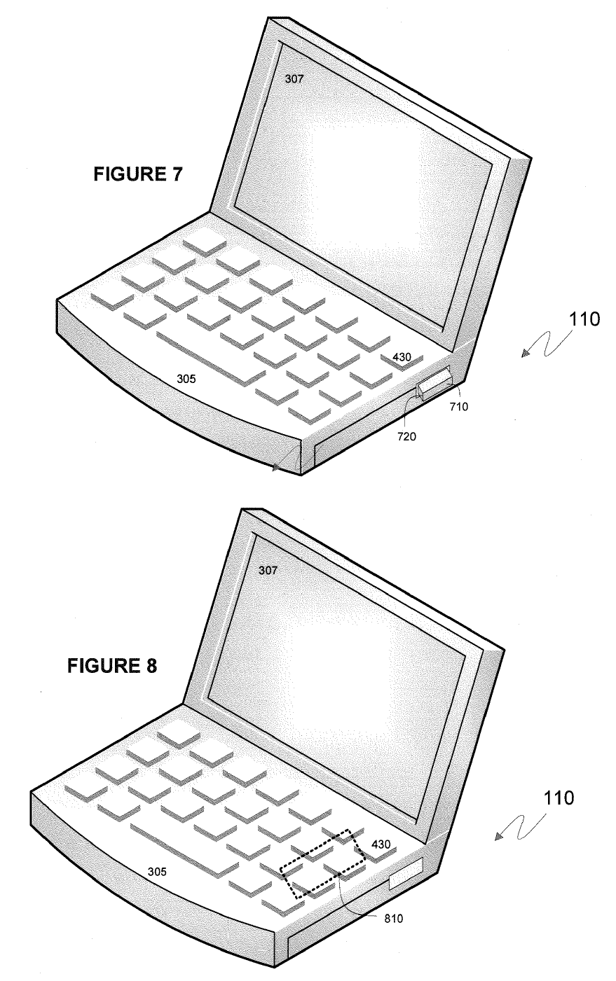

The video output interface 320 may additionally convey audio data, as is the case with certain HDMI interfaces. Alternatively, to support audio data, a separate cable (not shown) can be included to extend from the external hardware circuitry 310 to an audio jack (not shown) on the computer 305. In that case, the external hardware circuitry 310 includes an audio interface (not shown) to receive the audio data, which can be compressed by the compressor 450. Similarly, a separate audio cable and associated circuitry can be provided with the external hardware circuitry described below in relation to FIGS. 5 and 7, if necessary.

FIG. 5 is an illustration of a computer system 110 with add-on external hardware circuitry 510, according to another physical form factor. Like the computer system depicted in FIG. 3, the computer system in FIG. 5 includes detachable external hardware circuitry to offload the data compression from the computer 305. Unlike the computer system depicted in FIG. 3, which utilizes a looped cabling technique for connecting to two different ports of the computer 305, the computer system in FIG. 5 utilizes a single-port dongle design. The dongle includes an external hardware circuitry 510 and a connector 520 (and optionally a data cable in between) that connects to a data interface port 350, which may be a USB receptacle or a PC card slot (e.g., PCMCIA (Personal Computer Manufacturer Interface Adaptor), Cardbus, or Expresscard). For a PC card implementation, for example, the electrical interface could be USB, PCI (Peripheral Component Interconnect) or PCIe (PCI Express), depending upon the PC card type and the available interface.

FIG. 6 is a high-level block diagram for the computer system 110 illustrated in FIG. 5. FIG. 6 shows some of the more pertinent components of the computer 305 and the external hardware circuitry 510 employed in generating a data stream suitable for transmission as depicted in FIG. 1, according to the physical form factor shown in FIG. 5. The computers 305 in FIGS. 4 and 6 are similar in many respects, and the same reference numbers are used to label common components. A primary difference between the embodiments depicted in FIGS. 4 and 6 is reflected in the latter's single data interface port 350. Whereas FIG. 4 depicts separate input and output ports, FIG. 6 depicts a combined I/O (input/output) port 350. In this embodiment, computer display graphics data is routed on an internal computer 610 bus and provided to the external hardware circuitry 510 through the data interface port 350. As shown in FIG. 6, the external hardware circuitry 510 comprises a compressor 450 and a bus interface 620, which connects to the connector 520, which can be connected to the data interface port 350.

FIG. 7 is an illustration of a computer system 110, according to another conceptual physical form factor. As shown in FIG. 7, the computer system 110 comprises a computer 305 that accepts a plug-in card 710 in a plug-in card slot 720 The plug-in card 710 houses external hardware circuitry that may be the same or similar to the circuitry illustrated in FIG. 6.

In any of the embodiments illustrated in FIGS. 5-7, the external data interface port 350 may be a USB connector electrically connected to the motherboard of the computer 305. A hot plug detection controller can be provided to detect when the external hardware circuitry 510 or 710 is connected to the data interface port 350. When a connection is detected, the computer 305 can route the display screen graphics data through the USB dongle and into standard USB electrical contacts. In this way, plugging in the dongle immediately signifies to the computer 305 that the user wants to display his/her desktop graphics on the wide-area display device 140.

FIG. 8 is an illustration of a computer system 110 with internal hardware circuitry 810. The internal hardware circuitry 810 may contain the same or similar hardware circuitry as illustrated in either FIG. 4 or 6. The internal hardware circuitry 810 may be, for example, an expansion card that can be connected to the motherboard of the computer 305, thereby allowing computer manufacturers to make the capabilities described herein an option available with the computer 305. As another example, the internal hardware circuitry 810 may be built into an integrated circuit or chipset included on the motherboard of the computer 305. One benefit of an internal add-on card is that it provides OEMs (Original Equipment Manufacturers) the ability to offer an optional value-added option.

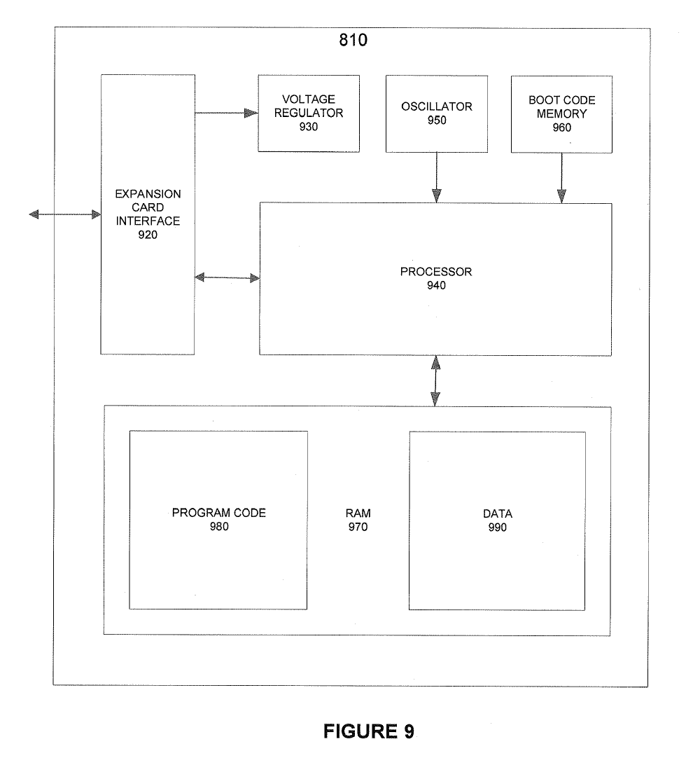

FIG. 9 is a block diagram of some of the more important components of the internal hardware circuitry 810, according to one embodiment. The internal hardware circuitry 810 comprises an expansion card interface 920, which may be, for example, a PCI, PCIe or USB interface. Any of the foregoing interfaces may utilize a Expresscard or minicard connector, for example. The internal hardware circuitry 810 also may comprise a voltage regulator 930. As shown, the voltage regulator 930 receives a power signal from the expansion card interface 920. If a power signal is not available from the expansion card, then the hardware circuitry 810 may alternatively comprise a separate power connection or its own power supply coupled to a power source (e.g., a battery). The voltage regulator provides power to the other components of the hardware circuitry 810 via power connections not shown.

The hardware circuitry 810 also comprises a processor 940 that performs the compression and in one implementation any other processing necessary to convert display screen graphics data into a suitable media stream. That additional processing may alternatively be done in the computer 305. The processor 940 may be, for example, a microprocessor, DSP (Digital Signal Processor), programmable array (e.g., FPGA (Field-Programmable Gate Array)) or an ASIC (Application-Specific Integrated Circuit). The processor 940 is typically a single chip but it may comprise multiple chips. The hardware circuitry also comprises an oscillator 950 that generates a clock signal for the processor 940 and any other clock signals needed by the hardware circuitry 810. A boot code memory 960 stores boot code for the processor 940. The boot code memory 960 may be ROM (read-only memory), for example. The hardware circuitry 810 also comprises RAM (random-access memory) 970 that stores both program code 980 and data 990. The RAM 970 is preferably high-speed memory, such as DDR2 (Double Data Rate 2) or DDR3 (Double Data Rate 3) type synchronous dynamic RAM. The data 990 in the RAM 970 may include temporarily stored graphics or other input data, algorithm parameters, and intermediate or final results generated by the processor 940. The program code 980 in the RAM 970 stores executable source code program instructions that implement the compression and any other processing algorithms performed by the processor 940.

Video graphics data can be transferred to the hardware circuitry 810 in a variety of ways. For example, the video data can be transferred directly over an internal high-bandwidth bus, such as a PCIe bus, to which the expansion card interface 920 connects. As another example, unused pins on the expansion card interface 920 can be connected to the video output. For instance, a minicard has both USB and PCIe interfaces, only one of which is needed as such and the other of which can have its pins connected to the video output lines. As yet another example, the hardware circuitry 810 can include a video connector (not shown in FIG. 9) (e.g., a mini-HDMI type C connector) that is connected to the video output via an internal cable within the computer 305.

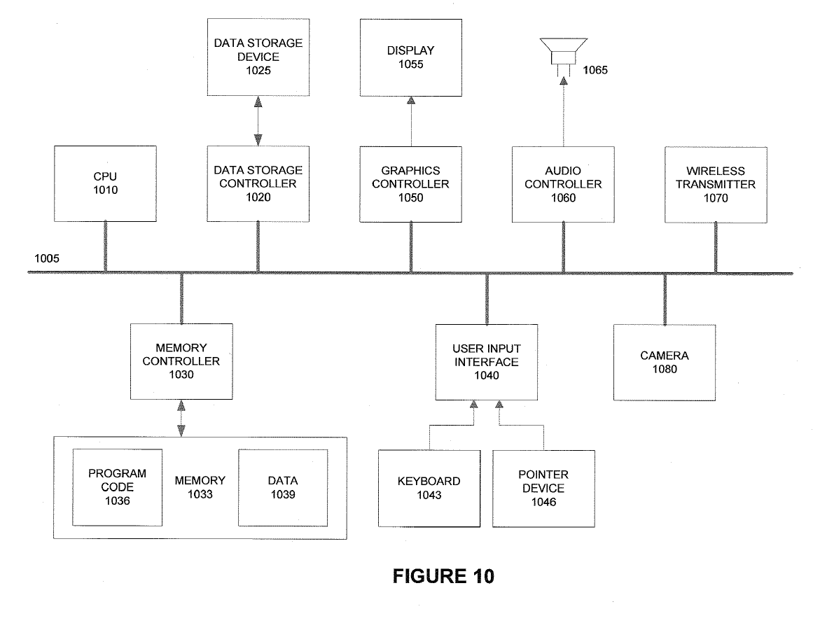

FIGS. 3-9 illustrate various aspects of examples in which the processing to create a media stream suitable for transmission to the media adaptor 130 is performed in dedicated hardware. Alternatively, that processing can be implemented in software executing on the CPU of the computer 110. One example of a computer 110 with software processing of the operative functionality is illustrated in the simplified computer architecture diagram in FIG. 10. As shown in FIG. 10, a computer 110 comprises a bus 1005 and a CPU 1010. With a sufficiently fast and powerful CPU 1010 or GPU (Graphics Processing Unit) (not shown), the computer 110 can perform the necessary processing. If the frame rate and/or resolution are decreased, then a less powerful CPU 1010 may be adequate. In other words, performance can be traded off for computational power, thereby enabling an implementation without additional hardware.

FIG. 10 illustrates many of the components and subsystems typically found in a computer. The following describes those components and subsystems in so far as they are pertinent to the intended operation of the computer 110 in the systems 100 or 200 (FIGS. 1 and 2). For example, a data storage controller 1020 is connected to the bus 1005 and interfaces to a data storage device 1025, such as a disk drive (typically an internal hard-disk drive). To create and process a media stream from raw graphics and audio data, the computer 110 is equipped with compression software. The software is an executable file specifically designed to generate a data stream compliant with a desired compression standard, such as an MPEG standard. The software is typically stored on a disk accessible by the data storage controller 1020. On startup, a kernel-level device driver typically assists the data storage controller 1020 to read the program from the data storage device 1025. The computer 110 operating system then relies on a memory controller 1030 to store the program contents into CPU accessible primary memory 1033 (typically RAM). The memory 1033 thereby includes program code 1036 and associated program data 1039 that are then accessible by the CPU 1010 via the memory controller 1030 such that computer instructions for processing can be executed.

Once loaded and executed, the processing software program would await an input from the user input interface 1040, preferably activated by either a keyboard 1043 or pointer device 1046, such as a mouse. The user input interface 1040 signals to the processing software that the user would like to start (or stop) displaying his or her local display screen on a remote wide-audience display, such as the display device 140 (FIG. 1 or 2). Whenever the user wishes to initiate display of his or her computer screen by the entering the appropriate input, the software program starts to sample data from a graphics controller 1050, which typically includes a frame buffer storing data that is used to drive a local computer display 1055.

As the graphics data is sampled and buffered, the processing software generates suitable frames and performs compression processing. When an MPEG compression standard is utilized, the processing software generates MPEG compatible frames, compresses the frame data, and stores the data into an MPEG compatible format. The MPEG standard and other compression standards also support the ability to encode mixed media data, so the processing software can also sample an audio controller 1060 for any audio data that would normally be played on a computer speaker 1065. The A/V data can then be combined to form a single media stream which can be transmitted by means of a wireless transmitter 1070 for reception by the media adapter 130 (FIG. 1 or 2). Alternatively, the wireless transmitter may be a network interface to a wired network on which the media adapter 130 is connected.

Optionally, a camera 1080, which may be a webcam, may be included as part of the computer 110. In that case, the software program can be configured to sample and to compress the camera's video data for transmission to the display device 140 or for other purposes. FIG. 10 depicts the camera 1080 included internally in the computer 110; however, in an alternative embodiment not depicted, the camera 1080 can be connected to the computer 110 externally through a peripheral interface (such as a USB interface) not shown. With either an internal or an external camera, the user can preferably configure the software to select the source of video data to process.

In a similar vein, the hardware implementations of the processing described herein can be utilized with a camera. A camera operable with the processing described herein may be connected to a peripheral port of the computer 110 and directed to the hardware circuitry rather than the local display screen graphics data. Alternatively, the external hardware circuitry 310, 510, or 710 may include a peripheral port to which a camera can be connected directly. If the compressor 450 has only a single input port, then a configurable switch can be included within the hardware circuitry to select either the camera or the local display screen as the input to the compressor 450. If the compressor 450 has dual input ports, then no switch is needed. Using the compression processing described herein with a camera can be beneficial in situations in which the compression processing provided by the hardware circuitry 310, 510, or 710 is better matched to the camera's resolution than the camera's own compression circuitry. Most existing computer webcams today have a sensor array with a greater resolution than the camera's own compression circuitry can fully utilize.

Although FIG. 10 depicts a single bus 1005, that is done for simplicity of presentation. Multiple buses connected by bus bridges may be employed.

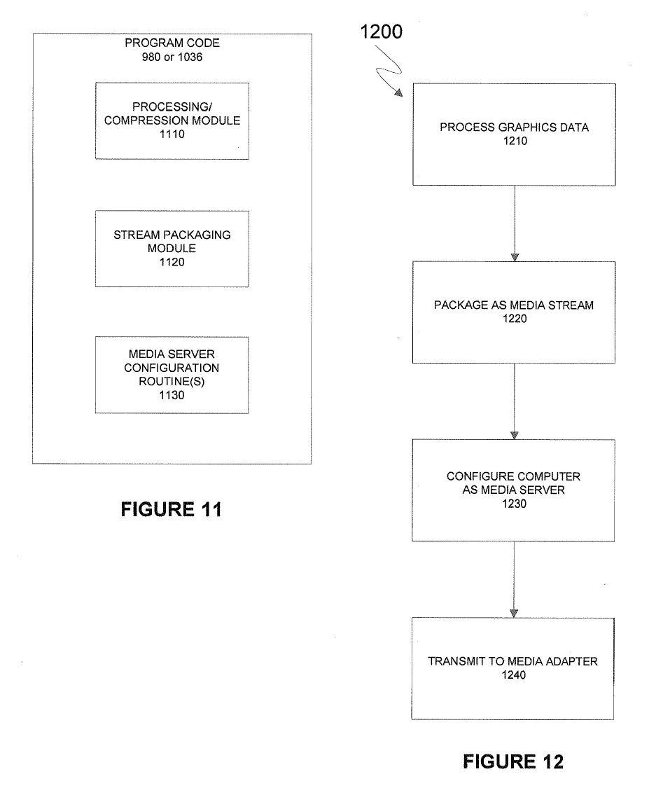

FIG. 11 is a computer memory diagram showing software modules and routines in the program code 980 (FIG. 9) or 1036 (FIG. 10), according to one embodiment. Included in the memory is a processing/compression module 1110 that processes the display screen graphics data, preferably on the fly as it is generated. The processing includes compression according to an algorithm supported by the target media adaptor 130 as well as any pre- or post-processing. Optionally, the processing/compression module or a separate module may also compress audio data generated by the computer 110 and normally played on a local speaker or speaker set at the computer 110. Also included is a stream packaging module 1120 that packages the processed graphics data as a media stream. The stream packaging module 1120 may also combine processed audio data, if any, into the media stream. Additionally, one or more media server configuration routines 1130 set up the computer 110 as a media server.

Although the processing/compression module 1110, the stream packaging module 1120, and the media server configuration routine(s) 1130 are shown together in FIG. 11, they may be distributed in different memories in a computer system. For example, one or both of the stream packaging module 1120 and the media server configuration routine(s) 1130 may be in the main memory of the computer 305 (e.g., the memory 1033), while the processing/compression module 1110 may stored in memory that is part of dedicated hardware (e.g., the RAM 970). In other words, the compression module may execute on a dedicated processor, while the less computationally demanding other routines may execute on the CPU 1010 of the computer 305.

Functionally, the computer system 110 includes (1) means for processing the display screen graphics data as the graphics data is generated by the computer, wherein the processing includes compressing, to yield processed display screen graphics data in a compressed format supported by the media adapter, (2) means for packaging the processed display screen graphics data as a media stream, (3) means for configuring the computer to be a media server of the media stream to the media adapter, and (4) means for transmitting the media stream from the computer to the media adapter, thereby facilitating display on the display device of the graphics content, substantially cloning or extending what appears on at least a portion of the display screen attached to the computer. The processing means can be a software or hardware module or a combination of hardware or software. The processing means for includes compression circuitry or a software algorithm for compression, as well as any pre- or post-compression circuitry or routines. Examples of the processing means include the compressor 450 described above and the processing/compression module 1110 in the program code 980 or 1036. The packaging means can also be a software or hardware module and may be combined with the processing module. Software versions of the packaging means may execute on either the CPU 1010 of the computer per se 305 or on the processor 940 included with the additional circuitry 310, 510, 710, or 810. The configuration means is typically software executing on the CPU 1010 of the computer per se 305, but it also may execute on another processor. The transmitting means may be the wireless transmitter 460, which is typically included as part of a wireless modem in most computers 305. Alternatively, the transmitting means may be part of network connection included as part of the computer 305 or provided in the additional hardware circuitry 310, 510, 710, or 810.

### III. Methods and Processes

The systems, computers and devices described above and illustrated in various respects in FIGS. 1-11 are capable of performing various methods in hardware and/or software. Representative examples of such methods are described next with reference to FIGS. 12-16.

FIG. 12 is a simplified flowchart of a method 1200 used to process graphics data into a media stream suitable for transmission to the media adapter 130, according to one embodiment. The method 1200 processes graphics data at step 1210, which includes compressing the data, to yield processed display screen graphics data. According to one embodiment, the step 1210 comprises sampling a raw video stream directly from a graphics controller frame buffer at a pre-configured refresh rate and resolution. Operating systems can provide direct access to the graphics data through proprietary application programming interfaces (APIs). Therefore, software programs running locally on the computer 110 can access the frame buffer directly and sample the pixel-level video data. In other embodiments, the video data is accessible through data interface ports including DVI or VGA ports. In these embodiments, a video receiver interface is required to convert the DVI or VGA signal into discrete video data samples. As sample frames (i.e., images) are buffered, a compression algorithm compresses the frames into an acceptable format and then places the compressed frames into a container, typically called an “elementary stream” for an MPEG format.

As graphics data is encoded and buffered, the method 1200 then packages the processed data at step 1220 as a media stream. When the H.264/AVC compression algorithm is employed, the step 1220 involves packetization of the compressed data into an elementary stream. In one embodiment, the step 1220 segments an elementary stream into groups of bits and attaches a packet header that identifies the particular elementary stream. The step 1220 may be performed by a packetizer module, which may be implemented in hardware or software. The output of the packetizer is sometimes called a packet elementary stream (PES).

The method 1200 also configures the computer 110 to be a media server at step 1230. According to one embodiment, when a transport stream (TS) is ready for transport through the transmission channel, the method 1200 initiates a file transfer, preferably using standard network protocols. The media adapter 130 can issue a hypertext transfer protocol (HTTP) request for the TS data. The computer 110 can respond with file header information and can then begin a real-time file stream. The configuring step 1230 can be performed before, after, or simultaneously with the processing step 1210 and/or the packaging step 1220. As depicted in the final step 1240 of the method 1200, the TS packets are transmitted when they are processed and available for transport. According to one embodiment, the TS packets are transmitted in 188 byte groups.

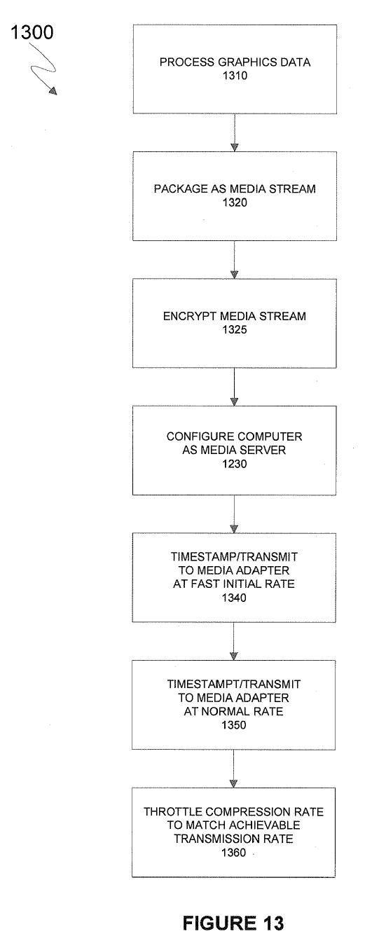

FIG. 13 is a flowchart of a method 1300 according to another embodiment. The method 1300 differs from the method 1200 in several respects. First, the method 1300 involves audio data in addition to graphics data. Thus, the method 1300 processes A/V data at step 1310 and packages that data together at step 1320. According to one embodiment, both the audio and video data are compressed and packetized individually, and a multiplexer combines them as a single stream. Separate processing is convenient when the A/V data is timestamped, such as when certain versions of HDMI are utilized, to permit re-combination of the audio and video data. According to one example, the audio can be compressed according to an AC-3 (also known as Dolby digital) codec, the video can be compressed according to the H.264 standard, and a multiplexer can combine them both into an MPEG program stream. A multiplexer combines the time stamped PES data into a single program stream that is suitable for network transport in a transport stream. In one embodiment, dedicated hardware, such as the hardware circuitry 310, 510, 710 or 810 performs the video compression, while the audio compression, which is less computationally demanding, is performed in software executing on the computer per se 305. Alternatively, both audio and video processing can be performed in hardware, or both audio and video processing can be performed in software.

The method 1300 also encrypts the media stream at a step 1325, which can be desirable when wireless transmission is employed as a way to prevent unauthorized reception of the transmission. Alternatively or additionally, the encrypting step may be performed before the packaging step 1230 and/or the processing step 1310. The configuration step 1230 is the same in the method 1300 as in the method 1200. Depending on the nature of the transmission channel, the encryption step 1325 may be part of the transmission steps 1340 and 1350. For example, some wireless LANs utilize the WPA (WiFi Protected Access) security protocol when transmitting.

The method 1300 also employs a different transmission technique designed to reduce initial latency for viewing the media stream at the display device 140. A typical media adapter has a buffer, which is useful for playing the media smoothly when transmission errors cause retransmission or other factors disrupt the smooth filling of the buffer. However, a disadvantage of having such a buffer is that filling the buffer causes an initial delay when first viewing the stream. For example, if the size of the buffer is 1 MB (megabyte or 2²⁰ 8-bit bytes) and the transmission rate is 1 Mbps (megabits/second or 2²⁰ bits per second), then it will take eight seconds to fill the buffer. A faster transmission rate will fill the buffer more quickly and therefore reduce that initial latency. For example, an 8 Mbps transmission rate will fill the same 1 MB buffer in only one second. To reduce this initial latency, the method 1300 transmits the media stream at a faster initial rate for an initial period of time at step 1340 to force the buffer to fill and then transmits the media stream at a normal, real-time rate at step 1350. This is possible when the transmission rate can be varied. As an alternative to achieve the same effect, the method 1300 can alter the timestamps associated with the packets in the media stream. Specifically, the timestamps can be altered so that the time difference between adjacent packets is less than real time for the first few initial packets. That can cause some media adapters 130 to empty its buffer more quickly and thereby reduce initial latency.

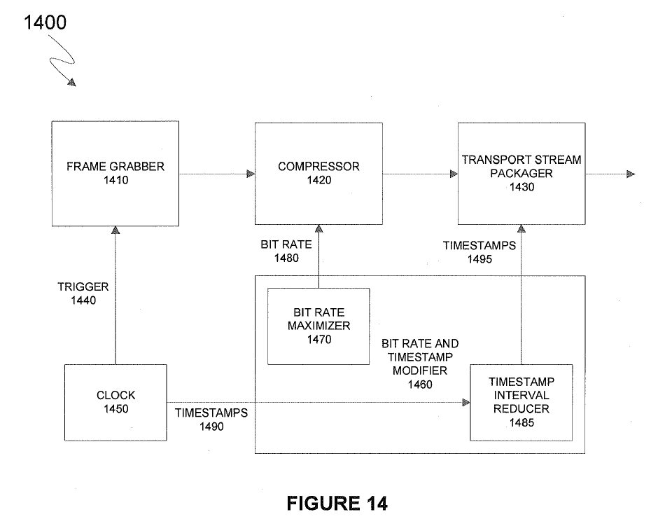

FIG. 14 is a block diagram of one example of a system 1400 that can implement the step 1340 or a similar step. The system 1400 comprises a frame grabber 1410 that grabs frames of uncompressed graphics data from a frame buffer or other graphics data source and supplies those frames to a compressor 1420, which generates compressed frames, which are in turn sent to a transport stream packager 1430, which generates a stream suitable for transmission. The frame grabber 1410 is triggered by a trigger signal 1440 generated by a clock 1450. A pulse or transition of the trigger signal 1440 causes the frame grabber 1410 to grab a new frame. In a steady state, the compressor 1420 operates according to a nominal bit rate parameter, and the transport stream packager inserts timestamps having nominal, real-time values. However, during a start-up interval, a bit rate and timestamp modifier 1460 can operate to modify the bit rate and timestamps. The bit rate and timestamp modifier 1460 includes a bit rate maximizer 1470 that increases (preferably maximizes) the bit rate 1480 parameter according to which the compressor 1420 operates. The bit rate and timestamp modifier 1460 also includes a timestamp interval reducer 1485 that modifies timestamps 1490 generated by the clock 1450 so that the interval between consecutive timestamps 1495 is smaller, preferably by a factor proportional to the change in bit rate. The bit rate and timestamp modifier 1460 shuts down after an initial interval, thereafter returning the bit rate 1480 to the nominal value and simply passing the timestamps 1490 generated by the clock 1450 to the transport stream packager 1430 without modification.

Some media adapters 130 require that a media file size be specified at or before playing of the file begins. Streaming of concurrently produced media in real time is not compatible with a fixed file size requirement. To overcome this limitation a very large file size can be specified, or the request can be ignored until the media adapter 130 stops asking. However, in some cases a disadvantage of specifying a very large file size or failing to specify a file size is exacerbation of the initial latency problem.

The method 1300 also can throttle the compression rate upward or downward to better match the achievable transmission rate at step 1360. The step 1360 involves measuring the transmission rate of the media stream, comparing the measured transmission rate to the compression rate, and determining if the compression rate should be increased or decreased to better match the transmission rate. This is a feedback loop for the purpose of flow control, which can be especially useful when wireless transmission is employed, as fading, interference and other phenomena can affect the effective transmission rate. Higher rate compression results in less data to be transmitted and is therefore better suited to a poor quality transmission channel, although a higher compression rate can adversely affect the quality of the signal by creating more compression loss. Lower rate compression can result in less compression loss but also requires more bandwidth and is therefore better suited to a higher quality transmission channel. One technique for measuring the effective bandwidth or transmission rate is for the computer 110 to write a file of a known length to the media adapter 130 and to measure the time it takes for that writing process to complete. The effective transmission rate is determined by the size of the file divided by the writing time. Transmission rate measurements can be taken at regular or irregular intervals. For example, measurements can be taken when there is little or no motion in the video data, in which case little image data needs to be transmitted. At such times, a bandwidth measurement does not impact the video quality as much as other times. A motion estimator within an MPEG-4 video compression algorithm can provide an indication of the level of motion in the video data. Alternatively, a transmission packet error rate (e.g., retransmission request rate) or other quality-of-service indicator, which is a proxy for the effective transmission rate, can be used as the feedback signal to control the compression rate upward or downward.

In a multiple-computer system, such as the one illustrated in FIG. 2, it can be useful to employ a technique to determine which of the multiple computers 110 should be selected to share its display on the display device 140. For example, when utilizing Windows® Media Center, only one computer can communicate with the media adapter 130 at any time. In that case, the computer that desires to share its display can configure the media adapter 130 to communicate with his or her computer 110. Thereafter, the user can activate and deactivate display sharing, such as by depression of a button on the computer 110, as desired. As another example, when using UPnP, each computer 110 can turn on or off its desktop server. When a server is on, it registers with the media adapter 130, which maintains a list of all registered media servers. A desired server can be selected by operation of the media adapter 130's user interface, typically by operation of a remote control to navigate through menus on the display device 140.

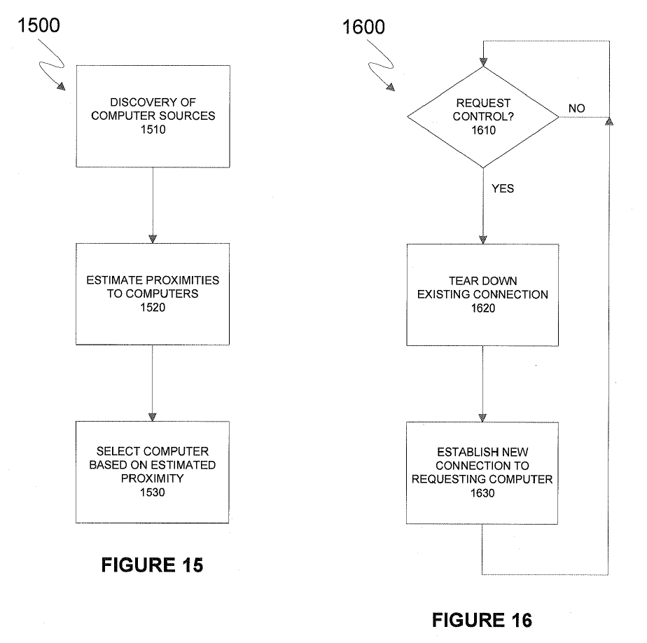

It may be more desirable to employ a technique for selecting which one of the computers 110 will share its display without having to operate the user interface of the media adapter 130. Having to operate another user interface of another device complicates the process for the user, especially when the additional user interface is not easy to use, as may be the case for some media adapters. FIGS. 15 and 16 are flowcharts of contention methods 1500 and 1600, respectively, for selecting one of a multiple of computers without operation of the user interface of the media adapter 130.

The method 1500 begins by discovering the computer sources 110 at step 1510. The discovery step 1510 may be accomplished using a standard discovery protocol, such as UPnP. The method 1500 estimates proximities between the media adapter 130 and each of the computers 110 at step 1520. One technique for implementing the step 1520 is based on signal strength measurements and involves measuring the strength of a signal transmitted between a computer 110 and the media adapter 130. Typically, a stronger signal correlates to a shorter distance. One convenient way to enable a signal strength measurement is to set up an ad-hoc point-to-point connection between a computer 110 and the media adapter 130. The ad-hoc connection facilitates straightforward signal strength measurement and can be used initially for that purpose and need not be used to transmit the media stream.

Another technique for implementing the step 1520 is to utilize timestamps embedded in the signals, such as those in a wireless 802.11 protocol. For example, time-of-arrival ranging measurements per the 802.11v standard can be employed. These timestamps can then be utilized to estimate distance. A combination of signal strength and time-of-arrival techniques can be utilized for the step 1520. Next, the method 1500 selects a computer based on the estimated proximity, at step 1530, according to a desired decision criteria, such as by choosing the computer having the closest estimated proximity. Alternatively, the computers can be ranked based on the estimated proximities and presented to the user in an ordered list for the user to choose one as the selection.

Alternatively, the proximity scheme can be used by a computer 110 to select which one of the multiple media adapters it will utilize. In that case, the method 1500 can be performed as described above with a computer 110 in place of the media adapter and multiple candidate media adapters in place of the computers 110.

FIG. 16 is a flowchart of a method 1600 for selecting one of a multiple of computers, according to another embodiment. The method 1600 implements a protocol whereby control is always granted to the computer that next requests it. The method 1600 monitors for a request to take control at step 1610. When a request is detected, the method 1600 tears down the existing connection to the media adapter, if any, at step 1620, and establishes a new connection to the requesting computer, at step 1630. The method 1600 then returns to the step 1610 to resume monitoring for the next request. The request may be initiated at a computer 110 by activation of an input, such as a key depression, that signifies a desire by a user to share its local screen on the remote display device 140. A computer 110 may be configured to participate in or to opt out from the contention method 1600 by setting a preference in the computer's control panel, for example. A computer 110 that opts out of the method 1600 does not relinquish control of the remote display device 140 when another computer 140 requests control.

The methods and systems illustrated and described herein can exist in a variety of forms both active and inactive. For example, they can exist partially or wholly as one or more software programs comprised of program instructions in source code, object code, executable code or other formats. Any of the above can be embodied in compressed or uncompressed form on a computer-readable medium, which include storage devices. Exemplary computer-readable storage devices include conventional computer system RAM (random access memory), ROM (read only memory), EPROM (erasable, programmable ROM), EEPROM (electrically erasable, programmable ROM), flash memory and magnetic or optical disks or tapes.

### IV. Conclusion

The terms and descriptions used above are set forth by way of illustration only and are not meant as limitations. Those skilled in the art will recognize that many variations, enhancements and modifications of the concepts described herein are possible without departing from the underlying principles of the invention. The scope of the invention should therefore be determined only by the following claims and their equivalents.

1. A method for masquerading computer display screen graphics data as a media stream supported by a media adapter having capabilities to receive a media stream, to decompress a received media stream and to interface with a display device to cause the display device to display video content represented by decompressed received media stream, wherein the display screen graphics data is uncompressed pixel-level data generated by the computer and stored in a frame buffer in the computer so as to represent graphics content displayable on a display screen attached to the computer when the computer operates in a normal display mode, the method comprising:
processing the display screen graphics data as the graphics data is generated by the computer, wherein the processing includes compressing, to yield processed display screen graphics data in a compressed format supported by the media adapter;
packaging the processed display screen graphics data as a media stream;
configuring the computer to be a media server of the media stream to the media adapter; and
transmitting the media stream from the computer to the media adapter, thereby facilitating display on the display device of the graphics content, substantially cloning or extending what appears on at least a portion of the display screen attached to the computer.

2. A method according to claim 1, wherein the computer also generates audio data representing audio content normally played on at least one speaker attached to the computer when the computer operates in the normal display mode, and wherein the method further comprises:
processing the audio data as the audio data is generated by the computer, wherein the processing includes compressing, to yield processed audio data in a compressed format supported by the media adapter; and
packaging the processed audio data as part of the media stream, thereby facilitating playing of the audio content on a sound system associated with the display device.

3. A method according to claim 1, wherein the media adapter is built in to the display device.

4. A method according to claim 1, wherein the media adapter is at least part of a device separate from the display device.

5. A method according to claim 4, wherein the device of which the media adapter is a part is a gaming system.

6. A method according to claim 1, wherein the display device comprises a television.

7. A method according to claim 1, wherein the display device comprises a projector.

8. A method according to claim 1, wherein the transmitting step comprises transmitting the media stream from the computer to the media adapter through at least one wireless link.

9. A method according to claim 8, further comprising:
measuring the rate of transmission of the media stream from the computer to the media adapter to yield a measured transmission bit rate; and
determining if a compression rate should be adjusted to better match the measured transmission bit rate and if so adjusting the compression rate accordingly.

10. A method according to claim 8, further comprising:
encrypting the processed graphics data prior to the step of transmitting.

11. A method according to claim 1, wherein the media stream comprises timestamps, and the method further comprises:
timestamping the media stream at a rate faster than real time for an initial period, whereby latency for viewing the graphics content on the display device is reduced

12. A method according to claim 1, further comprising:
initially transmitting the media stream at a first rate and subsequently, after some time period, transmitting the media stream at a second rate less than the first rate, whereby latency for viewing the graphics content on the display device is reduced.

13. A method according to claim 1, wherein the computer and the media adapter are connected by and communicate via a local area network.

14. A method according to claim 13, wherein the local area network operates with at least one wireless link according to an IEEE 802.11 standard.

15. A method according to claim 1, wherein the computer and the media adapter communicate via an Internet protocol.

16. A method according to claim 1, further comprising:
detecting activation of an input on the computer that signifies a desire by a user of the computer to change from the normal display mode to a remote display mode in which the graphics content is displayed on the display device,
wherein the processing, packaging, configuring and transmitting steps are performed in response to activation of the input.

17. A method according to claim 1, wherein said computer is one of a plurality of computers that can wirelessly send video to the media adapter, the method further comprising:
estimating a proximity between the media adapter and each of the plurality of computers; and
selecting said computer and thereby performing the processing, packaging, configuring, and transmitting steps, only if the estimated proximity between the media adapter and said computer is not less than the estimated proximities between the media adapter and each of the plurality of computers except for said computer.

18. A method according to claim 1, wherein said computer is one of a plurality of computers that can wirelessly send video to the media adapter, the method further comprising:
detecting activation of an input at another one of the plurality of computers other than said computer, the input signifying a desire by a user of said another one of the plurality of computers to have its video data displayed on the display device;
as a result of detection of the input, discontinuing display of video content originating said computer, receiving video data originating from said another one of the plurality of computers, and displaying on the display device video content represented by the received video data originating from said another one of the plurality of computers.

19. A method according to claim 1, wherein said computer is one of a plurality of computers that can wirelessly send video to the media adapter, wherein the media adapter comprises a user interface operable by use of a media adapter remote control, and wherein the media adapter remote control is used to select which of the plurality of computers has its display screen graphics data displayed on the display device.

20. A system for masquerading computer display screen graphics data as a media stream supported by a media adapter having capabilities to receive a media stream, to decompress a received media stream and to interface with a display device to cause the display device to display video content represented by the decompressed received media stream, wherein the display screen graphics data is pixel-level data generated by the computer and stored in a frame buffer so as to represent graphics content displayable on a display screen attached to the computer when the computer operates in a normal display mode, the system comprising:
means for processing the display screen graphics data as the graphics data is generated by the computer, wherein the processing includes compressing, to yield processed display screen graphics data in a compressed format supported by the media adapter;
means for packaging the processed display screen graphics data as a media stream;
means for configuring the computer to be a media server of the media stream to the media adapter; and
means for transmitting the media stream from the computer to the media adapter, thereby facilitating display on the display device of the graphics content, substantially cloning or extending what appears on at least a portion of the display screen attached to the computer.

21. A computer readable medium on which are embedded software code that performs a method for masquerading computer display screen graphics data as a media stream supported by a media adapter having capabilities to receive a media stream, to decompress a received media stream and to interface with a display device to cause the display device to display video content represented by decompressed received media stream, wherein the display screen graphics data is pixel-level data generated by the computer and stored in a frame buffer so as to represent graphics content displayable on a display screen attached to the computer when the computer operates in a normal display mode, the method comprising:
processing the display screen graphics data as the graphics data is generated by the computer, wherein the processing includes compressing, to yield processed display screen graphics data in a compressed format supported by the media adapter;
packaging the processed display screen graphics data as a media stream; and
configuring the computer to be a media server of the media stream to the media adapter, whereby the media stream can be transmitted from the computer to the media adapter, thereby facilitating display on the display device of the graphics content, substantially cloning or extending what appears on at least a portion of the display screen attached to the computer.

22. A computer system with the capability to masquerade computer display screen graphics data as a media stream supported by a media adapter having capabilities to receive a media stream, to decompress a received media stream and to interface with a display device to cause the display device to display video content represented by decompressed received media stream, the computer system comprising:
a computer that generates the display screen graphics data as pixel-level data and stores the display screen graphics data in a frame buffer;
a display screen connected to the computer and nearby the computer, wherein images representing the graphics content are displayable on the display screen when the computer operates in a normal display mode;
a module that processes the display screen graphics data as the graphics data is generated by the computer, wherein the processing includes compressing, to yield processed display screen graphics data in a compressed format supported by the media adapter;
a module that packages the processed display screen graphics data as a media stream;
software that configures the computer to be a media server of the media stream to the media adapter; and
a transmitter that transmits the media stream from the computer to the media adapter, thereby facilitating display on the display device of the graphics content, substantially cloning or extending what appears on at least a portion of the display screen.

23. A computer system according to claim 22, further comprising:
a camera that generates image data, wherein the processing circuitry is also utilized to compress the image data generated by the camera.

24. A computer system according to claim 22, wherein the module that processes the display screen graphics data is a software module.

25. A computer system according to claim 22, wherein the module that processes the display screen graphics data is a hardware module.

26. A computer system according to claim 25, wherein the hardware module is external to the computer that generates the display screen data.

27. A computer system according to claim 25, wherein the computer that generates the display screen data comprises an external housing, and wherein the hardware module is located internally within the housing.

28. A device for use with a computer to masquerade computer display screen graphics data as a media stream supported by a media adapter having capabilities to receive a media stream, to decompress a received media stream and to interface with a display device to cause the display device to display video content represented by decompressed received media stream, wherein the display screen graphics data is pixel-level data generated by the computer and stored in a frame buffer so as to represent graphics content displayable on a display screen attached to the computer when the computer operates in a normal display mode, the device comprising:
processing circuitry for processing the display screen graphics data as the graphics data is generated by the computer, wherein the processing circuitry includes compression circuitry, to yield processed display screen graphics data in a compressed format supported by the media adapter,
whereby a module associated with the computer packages the processed display screen graphics data as a media stream so that when the computer is configured to be a media server of the media stream to the media adapter and when the media stream is transmitted from the computer to the media adapter, the graphics content is displayed on the display device, thereby substantially cloning or extending what appears on at least a portion of the display screen attached to the computer.

29. A device according to claim 28, wherein the processing circuitry is located on a circuit card installed internally in the computer.

30. A device according to claim 28, wherein the processing circuitry is connected to the computer externally.

31. A device according to claim 30, further comprising:
a video cable having a connector at a first end, the connector being connectable to a video output interface of the computer, the video cable further having a second end connected to the processing circuitry such that the graphics data is transferred through the video cable to the processing circuitry; and
a computer bus cable having a first end connected to the processing circuitry and a second end having a connector connectable to an external bus interface on the computer such that the processed display screen graphics data is transferred from the processing circuitry to the computer.

32. A device according to claim 30, wherein the device is a dongle further comprising:
a connector having a first end and a second end, the first end of the connector being connectable to the computer via an external interface of the computer, wherein the second end of the connector is connected to the processing circuitry.

33. A device according to claim 30, wherein the processing circuitry is housed in a plug-in card connectable to a plug-in card connector on the computer.

34. A device according to claim 30, wherein the processing circuitry further comprises:
a detector configured to detect when the processing circuitry is connected to the computer and to thereby generate a plug-in detection signal, wherein the plug-in detection signal causes the processing circuitry to begin operation, thereby causing the computer display screen graphics data to be displayed on the display device.

35. A device according to claim 28, further comprising as part of the device:
the module associated with the computer that packages the processed display screen graphics data as a media stream.

36. A system for use with a computer to masquerade computer display screen graphics data as a media stream, wherein the display screen graphics data is pixel-level data generated by the computer and stored in a frame buffer so as to represent graphics content displayable on a display screen attached to the computer when the computer operates in a normal display mode, the system comprising:
a media adapter having capabilities to receive the media stream, to decompress a received media stream and to interface with a display device to cause the display device to display video content represented by decompressed received media stream;
a processing module at the computer that processes the display screen graphics data as the graphics data is generated by the computer, wherein the processing circuitry includes compression circuitry, to yield processed display screen graphics data in a compressed format supported by the media adapter; and
a module at the computer that packages the processed display screen graphics data as a media stream so that when the computer is configured to be a media server of the media stream to the media adapter and when the media stream is transmitted from the computer to the media adapter, the graphics content is displayed on the display device, thereby substantially cloning or extending what appears on at least a portion of the display screen attached to the computer.

37. A system according to claim 36, further comprising:
the display device interfaced to the media adapter.

38. A method for determining which one of a plurality of computers should be selected to wirelessly send video to a media adapter having capabilities to wirelessly receive video data and to interface with a display device to cause the display device to display video content represented by video data, the method comprising:
estimating a proximity between the media adapter and at least one of the plurality of computers, thereby producing a at least one proximity estimate; and
selecting the computer by utilizing said at least one proximity estimate.

39. A method according to claim 38, wherein estimating a proximity for a computer comprises:
measuring a strength of a signal transmitted over a wireless link between the computer and the media adapter.

40. A method according to claim 38, wherein estimating a proximity for a computer comprises:
utilizing timestamps embedded in an 802.11v WLAN protocol utilized to communicate between the computer and the media adapter.

41. A method for a media adapter having capabilities to receive video data and to interface with a display device to cause the display device to display video content represented by video data to select one of a plurality of computers most recently requesting to have its video content displayed on the display device, the method comprising:
detecting activation of an input at one of the plurality of computers that signifies a desire by a user of said one of the plurality of computers to have its video data displayed on the display device;
as a result of detection of the input, discontinuing display of any video content originating from any of the plurality of computers other than said one of the plurality of computers, receiving video data originating from said one of the plurality of computers, displaying on the display device video content represented by the received video data originating from said one of the plurality of computers, and continuing to display on the display device said video content represented by the received video data originating from said one of the plurality of computers until detecting activation of an input at another one of the plurality of computers that signifies a desire by a user of said another one of the plurality of computers to have its video data displayed on the display device.

42. A method according to claim 41, further comprising:
utilizing a discovery protocol to determine the number of computers.

43. A method according to claim 42, wherein the discovery protocol is a universal plug and play protocol.
